(19) United States
(12) Patent Application Publication
(10) Pub. No.: US 2016/0140087 A1
(43) Pub. Date: May 19, 2016

(54) METHOD AND ELECTRONIC DEVICE FOR CONTROLLING DISPLAY

(71) Applicant: Samsung Electronics Co., Ltd., Gyeonggi-do (KR)

(72) Inventor: Min-Su SEO, Seoul (KR)

(73) Assignee: Samsung Electronics Co., Ltd.

(21) Appl. No.: 14/934,785

(22) Filed: Nov. 6, 2015

(30) Foreign Application Priority Data
Nov. 14, 2014 (KR) 10-2014-0159017

(51) Int. Cl. G06F 17/21

(52) U.S. Cl. CPC G06F 17/214

(57) ABSTRACT

A method of operating an electronic device is provided. The method includes linking text information and use information about the text information, storing the linked text information and use information in a database, analyzing a user preference for the text information based on the use information, and determining text information that will be displayed with priority based on the user preference.

### PRIORITY

This application claims priority under 35 U.S.C. §119(a) to Korean Application Serial No. 10-2014-0159017, which was filed in the Korean Intellectual Property Office on Nov. 14, 2014, the contents of which are incorporated herein by reference.

### BACKGROUND OF THE INVENTION

1. Field of the Invention

The present invention generally relates to a method and electronic device for controlling a display.

2. Description of the Related Art

With the growth of information in telecommunication technologies and semiconductor technologies, various kinds of electronic devices are evolving into multimedia devices that provide various multimedia services. For example, the electronic devices provide various multimedia services such as a messenger service, a broadcasting service, a wireless Internet service, a camera service, and a music play service.

An electronic device that provides the aforementioned services can have a display, and can show various screen information to a user through the display. This screen information can include a language that is often used by the user and text information in a foreign language. For example, when outputting the foreign language text information, the electronic device searches for a font suitable to the corresponding text information among fonts stored in a database, and outputs the foreign language text information through the display.

A conventional text display method can, upon reception of a text display request, search for a font suitable to a corresponding text among fonts stored in a database, and output the text in a loading scheme. However, when searching through the database for the corresponding font, the conventional text display method performs the font search with a previously fixed priority without considering a user's preference, e.g., a font that the user often uses or prefers, etc. Accordingly, unnecessary time is needed to display a desired text, therefore a text display speed decreases.

### SUMMARY OF THE INVENTION

The present disclosure has been made to address at least the problems and disadvantages described above, and to provide at least the advantages described below. Accordingly, an aspect of the present disclosure provides a method of operating an electronic device that includes linking text information and use information about the text information, storing the linked text information and use information in a database, analyzing a user preference for the text information based on the use information, and determining text information that will be displayed with priority based on the user preference.

Another aspect of the present invention provides an electronic device that includes a memory, a display, and a processor for controlling the memory and the display. The processor links text information and use information about the text information, stores the linked text information and use information in a database, analyzes a user preference for the text information based on the use information, and determines text information that will be displayed with priority based on the user preference.

### BRIEF DESCRIPTION OF THE DRAWINGS

The above and other aspects, features and advantages of the present invention will become more apparent from the following detailed description when taken in conjunction with the accompanying drawings in which:

FIG. 1 is a block diagram illustrating a network environment including an electronic device according to the present invention;

FIG. 2 is a block diagram illustrating an electronic device according to the present invention;

FIG. 3 is a block diagram illustrating a program module according to the present invention;

FIG. 4 illustrates interaction of modules of an electronic device for assigning priority to a font according to an embodiment of the present invention;

FIG. 5 is a flowchart illustrating a method for determining text information to be displayed with priority based on a user preference according to an embodiment of the present invention;

FIG. 6 is a flowchart illustrating a method for rearranging the priority of a font based on a loading count and use time of the font according to an embodiment of the present invention;

FIG. 7 is a table illustrating a state of storing a loading count and use time of a font according to an embodiment of the present invention;

FIG. 8 is a table illustrating determining a priority weight based on a loading count and use time of a font according to an embodiment of the present invention;

FIG. 9 is a diagram illustrating an algorithm of rearranging the priority of a font according to an embodiment of the present invention;

FIG. 10A to FIG. 10C are diagrams showing display wait time before and after applying an algorithm of rearranging the priority of a font according to an embodiment of the present invention;

FIG. 11 is a diagram showing a difference of a display wait time when moving from one webpage to other linked webpages according to an embodiment of the present invention; and

FIG. 12 is a flowchart illustrating a method for rearranging the priority of a font based on a use frequency and use time of the font according to an embodiment of the present invention.

### DETAILED DESCRIPTION OF THE PREFERRED EMBODIMENTS

Hereinafter, embodiments of the present invention will be described in connection with the accompanying drawings.

The present invention may have various embodiments, and modifications and changes may be made therein. Therefore, the present invention will be described in detail with reference to particular embodiments shown in the accompanying drawings. However, it should be understood that the present invention is not limited to the particular embodiments, but includes all modifications, equivalents, and/or alternatives within the spirit and scope of the present description. In the description of the drawings, similar reference numerals may be used to designate similar elements.

As used in describing embodiments of the present invention, the expressions “include”, “may include” and other conjugates refer to the existence of a corresponding disclosed function, operation, or constituent element, and do not limit one or more additional functions, operations, or constituent elements. Further, as used to describe the embodiments of the present invention, the terms “include”, “have”, and their conjugates merely denote a certain feature, numeral, step, operation, element, component, or a combination thereof, and do not exclude the existence or possibility of addition of one or more other features, numerals, steps, operations, elements, components, or combinations thereof.

In describing embodiments of the present invention, the expression “or” or “at least one of A or/and B” includes any or all of combinations of words listed together. For example, the expression “A or B” or “at least A or/and B” may include A, may include B, or may include both A and B.

In the present disclosure, expressions including ordinal numbers, such as “first” and “second,” etc., may modify various elements. However, such elements are not limited by the above expressions. For example, the above expressions do not limit the sequence and/or importance of the elements. The above expressions are used merely for the purpose of distinguishing an element from the other elements. For example, a first user device and a second user device indicate different user devices although both of them are user devices. For example, a first element may be referred to as a second element, and likewise a second element may also be referred to as a first element without departing from the scope of embodiments of the present invention.

When an element is referred to as being “coupled” or “connected” to any other element, it should be understood that not only the element may be coupled or connected directly to the other element, but also a third element may be interposed therebetween. Contrarily, when an element is referred to as being “directly coupled” or “directly connected” to any other element, it should be understood that no other element is interposed therebetween.

The terms used in embodiments of the present invention are used merely to describe one or more certain embodiments and are not intended to limit the present invention. As used herein, singular forms may include plural forms as well unless the context explicitly indicates otherwise. Furthermore, all terms used herein, including technical and scientific terms, have the same meaning as commonly understood by those of skill in the art to which the present invention pertains. Such terms as those defined in a generally used dictionary are to be interpreted to have the same meanings as the contextual meanings in the relevant field of art, and are not to be interpreted to have ideal or excessively formal meanings unless clearly defined in embodiments of the present invention.

An electronic device according to the present invention may be a device including a communication function. For example, the electronic device may include at least one of a Smartphone, a Tablet Personal Computer (PC), a Mobile Phone, a Video Phone, an Electronic Book (e-book) reader, a Desktop PC, a Laptop PC, a Netbook Computer, a Personal Digital Assistant (PDA), a portable multimedia player (PMP), an MP3 player, a Mobile Medical Appliance, a Camera, and a Wearable Device (e.g. a head-mounted-device, such as electronic glasses, electronic clothes, an electronic bracelet, an electronic necklace, an electronic appcessory, electronic tattoos, or a smartwatch).

According to certain embodiments, the electronic device may be a smart home appliance with a communication function. For example, the smart home appliance may include at least one of a television, a digital video disk (DVD) player, an audio, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic photo frame.

According to certain embodiments, the electronic device may include at least one of various medical appliances (e.g., magnetic resonance angiography (MRA), magnetic resonance imaging (MRI), computed tomography (CT), and ultrasonic machines), navigation equipment, a global positioning system (GPS) receiver, an event data recorder (EDR), a flight data recorder (FDR), automotive infotainment device, electronic equipment for ships (e.g., ship navigation equipment and a gyrocompass), avionics, security equipment, a vehicle head unit, an industrial or home robot, an automatic teller machine (ATM) of a banking system, and a point of sales (POS) of a shop.

According to certain embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter).

The electronic device according to the present invention may be a combination of one or more of the aforementioned various devices. Further, the electronic device according to the present invention may be a flexible device. Further, it will be apparent to those skilled in the art that the electronic device according to the present invention is not limited to the aforementioned devices.

Hereinafter, an electronic device according to the present invention will be described with reference to the accompanying drawings. The term “user” as used in embodiments of the present invention may indicate a person who uses an electronic device or a device (e.g., artificial intelligence electronic device) that uses an electronic device.

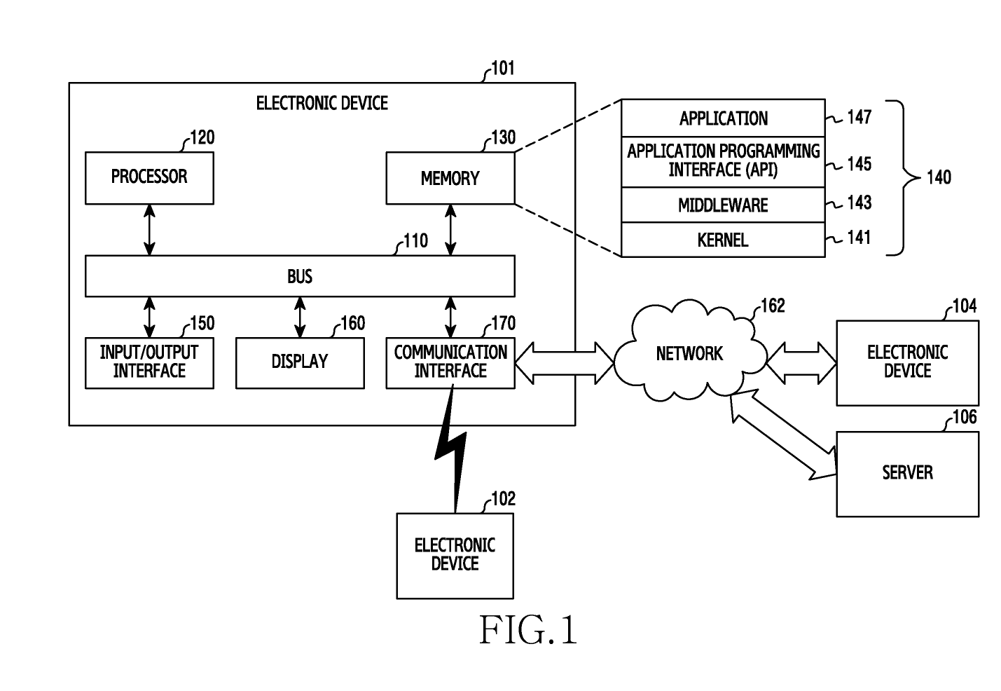

FIG. 1 is a block diagram of an example of a network environment, according to the present invention.

Referring to FIG. 1, an electronic device 101 includes at least one of a bus 110, a processor 120, a memory 130, an input/output interface 150, a display 160, and a communication interface 170. According to the present invention, at least one of the components of the electronic device 101 may be omitted, or other components may be additionally included in the electronic device 101.

The bus 110 is a circuit that interconnects the aforementioned elements and transmits communication signals (e.g., control messages) between the aforementioned elements.

The processor 120 carries out operations or data processing related to control and/or communication of at least one other component (for example, the memory 130, the input/output interface 150, the display 160, or the communication interface 170) of the electronic device 101.

The memory 130 stores commands or data (e.g., a reference pattern or a reference touch area) associated with one or more other components of the electronic device 101. According to one embodiment, the memory 130 stores software and/or a program 140. For example, the program 140 includes a kernel 141, a middleware 143, an application programming interface (API) 145, an application program 147, or the like, with one or more of the kernel 141, the middleware 143, and the API 145 being referred to as an Operating System (OS).

The kernel 141 controls or manages system resources (e.g., the bus 110, the processor 120, or the memory 130) used for performing an operation or function implemented by the other programs (e.g., the middleware 143, the API 145, or the application program 147). Furthermore, the kernel 141 provides an interface through which the middleware 143, the API 145, or the application program 147 may access the individual elements of the electronic device 101 to control or manage the system resources.

The middleware 143, for example, functions as an intermediary for allowing the API 145 or the application program 147 to communicate with the kernel 141 to exchange data. In addition, the middleware 143 processes one or more task requests received from the application program 147 according to priorities thereof. For example, the middleware 143 assigns priorities for using the system resources (e.g., the bus 110, the processor 120, the memory 130, or the like) of the electronic device 101, to at least one application of the application program 147. For example, the middleware 143 performs scheduling or loading balancing on the one or more task requests by processing the one or more task requests according to the priorities assigned thereto.

The API 145 is an interface through which the application 147 controls functions provided from the kernel 141 or the middleware 143, and may include, for example, at least one interface or function (e.g., instruction) for file control, window control, image processing, or text control.

The input/output interface 150 forwards instructions or data input from a user through an input/output device (e.g., various sensors, such as an acceleration sensor or a gyro sensor, and/or a device such as a keyboard or a touch screen), to the processor 120, the memory 130, or the communication interface 170 through the bus 110. For example, the input/output interface 150 provides the processor 120 with data on a user′ touch entered on a touch screen. Furthermore, the input/output interface 150 outputs instructions or data, received from, for example, the processor 120, the memory 130, or the communication interface 170 via the bus 110, through an output unit (e.g., a speaker or the display 160).

The display 160 includes, for example, a liquid crystal display (LCD), a light emitting diode (LED) display, an organic LED (OLED) display, a micro electro mechanical system (MEMS) display, an electronic paper display, and the like. The display 160, for example, displays various types of content (e.g., a text, images, videos, icons, symbols, and the like) for the user. The display 160 may include a touch screen and receive, for example, a touch, a gesture, proximity, a hovering input, and the like, using an electronic pen or the user's body part. According to an embodiment of the present invention, the display 160 may display a web page.

The communication interface 170, for example, sets communication between the electronic device 101 and an external device (e.g., a first external electronic device 102, a second external electronic device 104, or a server 106). For example, the communication interface 170 connects to a network 162 through wireless or wired communication to communicate with the external device (e.g., the second external electronic device 104 or the server 106).

The wireless communication may use at least one of, for example, long term evolution (LTE), LTE-advance (LTE-A), code division multiple access (CDMA), wideband CDMA (WCDMA), universal mobile telecommunications system (UMTS), wireless broadband (WiBro), and global system for mobile communications (GSM), as a cellular communication protocol. In addition, the wireless communication may include, for example, a short range communication 164. The short-range communication 164 may include at least one of, for example, wireless fidelity (Wi-Fi), Bluetooth™ (BT), near field communication (NFC), and GPS.

Each of the first external electronic device 102 and the second external electronic device 104 may be a device which is the same as or different from the electronic device 101. According to an embodiment of the present invention, the server 106 may include a group of one or more servers. According to the present invention, all or a part of operations performed in the electronic device 101 can be performed in the other electronic device or multiple electronic devices (e.g., the first external electronic device 102 or the second external electronic device 104 or the server 106). According to an embodiment of the present invention, when the electronic device 101 should perform some functions or services automatically or by a request, the electronic device 101 may make a request for performing at least some functions related to the functions or services by another device (e.g., the first external electronic device 102, the second external electronic device 104, or the server 106) instead of performing the functions or services by itself. The first external electronic device 102, the second external electronic device 104, or the server 106 may perform a function requested from the electronic device 101 or an additional function and transfer the performed result to the electronic device 101. The electronic device 101 can provide the requested function or service to another electronic device by processing the received result as it is or additionally. To this end, for example, cloud computing, distributed computing, or client-server computing technology may be used.

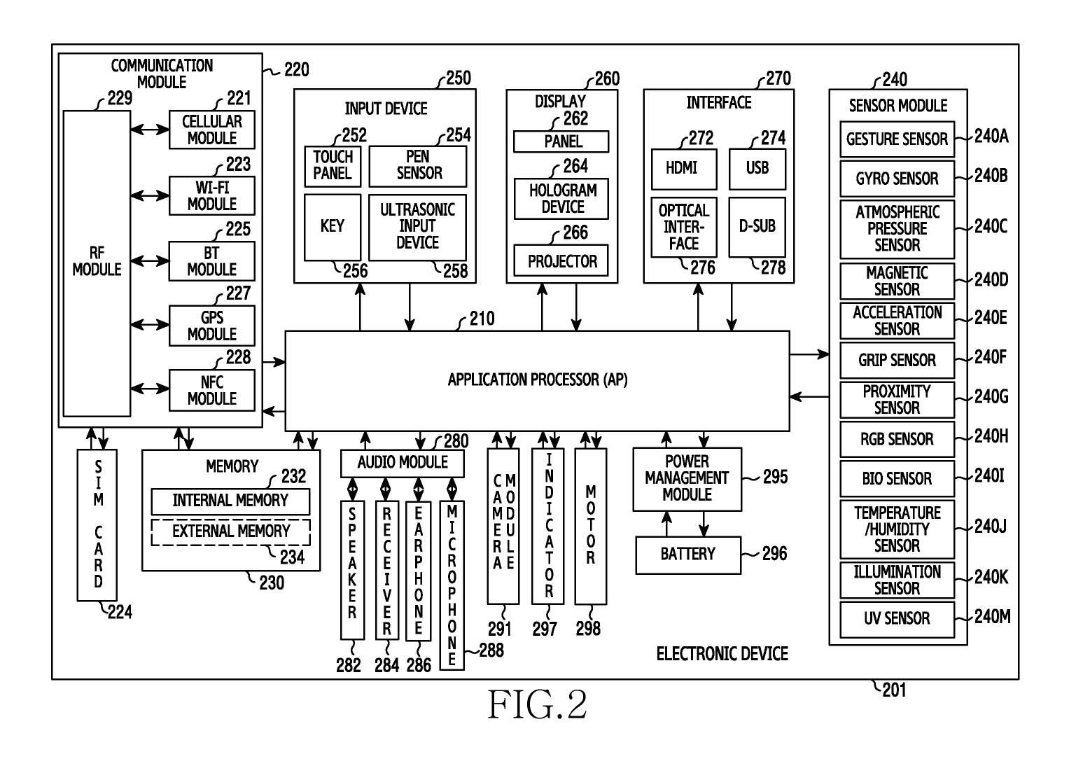

FIG. 2 is a block diagram of an example of an electronic device, according to the present invention.

The electronic device 201 may constitute, for example, the entirety or a part of the electronic device 101 illustrated in FIG. 1, or may expand all or some elements of the electronic device 101. Referring to FIG. 2, the electronic device 201 includes an application processor (AP) 210, a communication module 220, a subscriber identification module (SIM) card 224, a memory 230, a sensor module 240, an input device 250, a display 260, an interface 270, an audio module 280, a camera module 291, a power management module 295, a battery 296, an indicator 297, and a motor 298.

The AP 210 runs an operating system or an application program to control a plurality of hardware or software constituent elements connected to the AP 210, and may perform processing and operation of various data including multimedia data. The AP 210 may be, for example, implemented as a system on chip (SoC). According to an embodiment of the present invention, the AP 210 further includes a graphical processing unit (GPU). The AP 210 further includes at least one of other constitute elements (e.g., the cellular module 221). The AP 210 loads an instruction or data, which is received from a non-volatile memory connected to each or at least one of other constituent elements, to a volatile memory and processes the loaded instruction or data. In addition, the AP 210 stores in the non-volatile memory, data received from at least one of the other constituent elements or generated by at least one of the other constituent elements.

The communication module 220 (e.g., the communication interface 170) performs data transmission/reception in communication between the electronic device 201 (e.g., the electronic device 101) and other electronic devices connected through a network. According to an embodiment of the present invention, the communication module 220 includes cellular module 221, a Wi-Fi module 223, a BT module 225, a GPS module 227, an NFC module 228, and a radio frequency (RF) module 229.

The cellular module 221 provides a voice telephony, a video telephony, a text service, an Internet service, and the like, through a telecommunication network (e.g., LTE, LTE-A, CDMA, WCDMA, UMTS, WiBro, GSM, and the like). In addition, the cellular module 221 may, for example, use a SIM card 224 to perform electronic device distinction and authorization within the telecommunication network. According to an embodiment of the present invention, the cellular module 221 may perform at least some of functions that the AP 210 may provide. For example, the cellular module 221 performs at least one part of a multimedia control function.

The WiFi module 223, the BT module 225, the GPS module 227 and the NFC module 228 each may include, for example, a processor for processing data transmitted/received through the corresponding module. According to an embodiment of the present invention, at least some (e.g., two or more) of the cellular module 221, the WiFi module 223, the BT module 225, the GPS module 227 and the NFC module 228 are included within one IC or IC package.

The RF module 229 performs transmission/reception of data, for example, transmission/reception of an RF signal. The RF module 229 may include, for example, a transceiver, a power amplifier module (PAM), a frequency filter, a low noise amplifier (LNA), an antenna and the like. According to an embodiment of the present invention, at least one of the cellular module 221, the WiFi module 223, the BT module 225, the GPS module 227 or the NFC module 228 may perform transmission/reception of an RF signal through a separate RF module.

The SIM card 224 includes a SIM, and may be inserted into a slot provided in a specific position of the electronic device 201. The SIM card 224 includes unique identification information (e.g., an integrated circuit card ID (ICCID)) or subscriber information (e.g., an international mobile subscriber identity (IMSI)).

The memory 230 includes an internal memory 232 or an external memory 234. The internal memory 232 includes, for example, at least one of a volatile memory (e.g., a dynamic random access memory (DRAM), a static RAM (SRAM) and a synchronous DRAM (SDRAM)) or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a not and (NAND) flash memory, and a not or (NOR) flash memory).

According to an embodiment of the present invention, the internal memory 232 may be a solid state drive (SSD). The external memory 234 may further include a flash drive, for example, compact flash (CF), secure digital (SD), micro-SD, mini-SD, extreme digital (xD), a memory stick, and the like. The external memory 234 may be operatively connected with the electronic device 201 through various interfaces.

The sensor module 240 measures a physical quantity or detects an activation state of the electronic device 101, and converts measured or detected information into an electric signal. The sensor module 240 includes, for example, at least one of a gesture sensor 240A, a gyro sensor 240B, an air pressure sensor 240C, a magnetic sensor 240D, an acceleration sensor 240E, a grip sensor 240F, a proximity sensor 240G, a color sensor 240H (e.g., a red, green, blue (RGB) sensor), a bio-physical sensor 240I, a temperature/humidity sensor 240J, an illumination sensor 240K, a ultraviolet (UV) sensor 240M, and the like. Additionally or alternatively, the sensor module 240 may also include, for example, an E-nose sensor, an electromyography (EMG) sensor, an electroencephalogram (EEG) sensor, an electrocardiogram (ECG) sensor, an infrared (IR) sensor, an iris sensor, a fingerprint sensor, and the like. The sensor module 240 may further include a control circuit for controlling at least one or more sensors belonging therein.

The input device 250 includes a touch panel 252, a (digital) pen sensor 254, a key 256, an ultrasonic input device 258, and the like. The touch panel 252 may, for example, detect a touch input in at least one of a capacitive overlay scheme, a pressure sensitive scheme, an infrared beam scheme, and an acoustic wave scheme. The touch panel 252 may also include a control circuit. In a case of the capacitive overlay scheme, physical contact or proximity detection is possible. The touch panel 252 may further include a tactile layer, to provide a tactile response to a user.

The (digital) pen sensor 254 may be implemented in the same or similar method to receiving a user's touch input or by using a separate sheet for detection. The key 256 may include, for example, a physical button, an optical key, or a keypad. The ultrasonic input device 258 is capable of identifying data by detecting a sound wave in the electronic device 201 through an input tool generating an ultrasonic signal, and enables wireless detection. According to an embodiment of the present invention, the electronic device 201 may also use the communication module 220 to receive a user input from a connected external device (e.g., a computer or a server).

The display 260 (e.g., the display 160) includes a panel 262, a hologram device 264, or a projector 266. The panel 262 may be, for example, an LCD, an Active-Matrix Organic LED (AMOLED), and the like. The panel 262 may be, for example, implemented to be flexible, transparent, or wearable. The panel 262 may be constructed as one module along with the touch panel 252 as well. The hologram device 264 may use interference of light to show a three-dimensional image in the air. The projector 266 may project light to a screen to display an image. The screen may be, for example, located inside or outside the electronic device 201. According to an embodiment of the present invention, the display 260 may further include a control circuit for controlling the panel 262, the hologram device 264, or the projector 266.

The interface 270 includes, for example, a high-definition multimedia interface (HDMI) 272, a universal service bus (USB) 274, an optical interface 276, or a D-subminiature (D-sub) 278. Additionally or alternatively, the interface 270 includes, for example, a mobile high-definition link (MHL) interface, an SD card/multimedia card (MMC) interface or an infrared data association (IrDA) standard interface.

The audio module 280 converts a voice and an electric signal interactively. The audio module 280 may, for example, process sound information which is inputted or outputted through a speaker 282, a receiver 284, an earphone 286, the microphone 288, and the like.

The camera module 291 takes still pictures and moving pictures. According to an embodiment of the present invention, the camera module 291 includes one or more image sensors (e.g., a front sensor or a rear sensor), a lens, an image signal processor (ISP), or a flash (e.g., an LED or a xenon lamp).

The power management module 295 manages electric power of the electronic device 201. The power management module 295 includes, for example, a power management integrated circuit (PMIC), a charger IC, a battery, a battery gauge, and the like.

The PMIC may be, for example, mounted within an integrated circuit or an SoC semiconductor. A charging scheme may be divided into a wired charging scheme and a wireless charging scheme. The charger IC charges the battery 296, and prevents the inflow of overvoltage or overcurrent from an electric charger. According to an embodiment of the present invention, the charger IC includes a charger IC for at least one of the wired charging scheme or the wireless charging scheme. The wireless charging scheme may, for example, be a magnetic resonance scheme, a magnetic induction scheme, an electromagnetic wave scheme, and the like. A supplementary circuit for wireless charging, for example, a circuit, such as a coil loop, a resonance circuit, a rectifier, and the like, may be added.

The battery gauge may, for example, measure a level of the battery 296, a voltage during charging, a current or a temperature. The battery 296 generates or stores electricity, and uses the stored or generated electricity to supply power to the electronic device 201. The battery 296 may include, for example, a rechargeable battery or a solar battery.

The indicator 297 displays a specific status of the electronic device 201 or one part (e.g., the AP 210) thereof, for example a booting state, a message state, a charging state, and the like. The motor 298 may convert an electric signal into a mechanical vibration. The electronic device 101 may include a processing device (e.g., a GPU) for mobile TV support. The processing device for mobile TV support may, for example, process media data according to the standards of digital multimedia broadcasting (DMB), digital video broadcasting (DVB), a media flow, and the like.

Each of the above-described elements of the electronic device may include one or more components, and the name of a corresponding element may vary according to the type of electronic device. The electronic device according to the present invention may include at least one of the above-described elements and may exclude some of the elements or further include other additional elements. Further, some of the elements of the electronic device according to the present invention may be coupled to form a single entity while performing the same functions as those of the corresponding elements before the coupling.

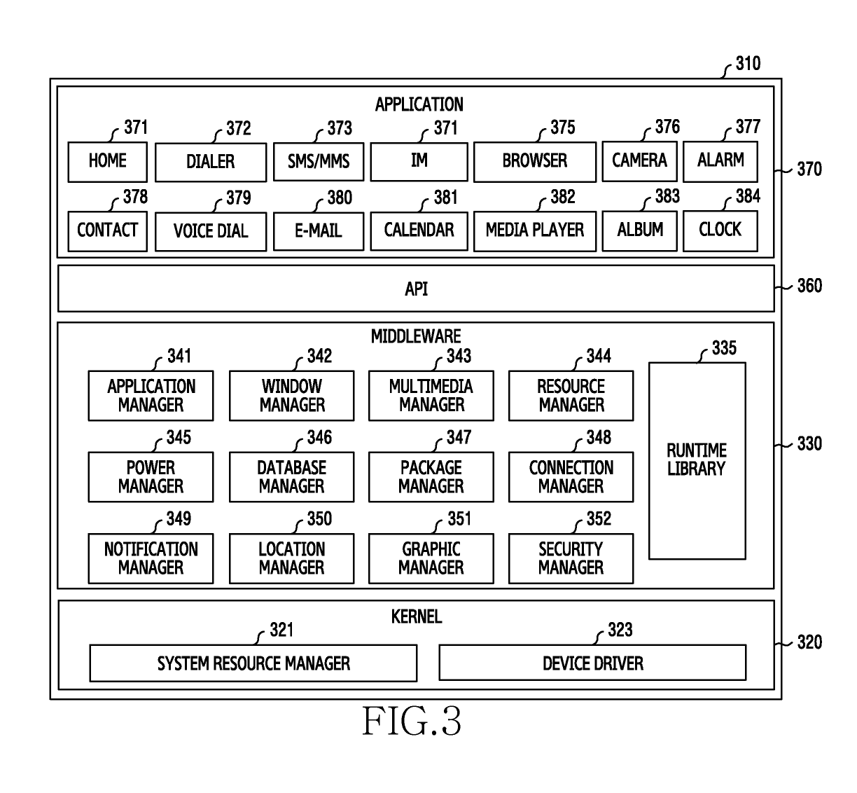

FIG. 3 is a block diagram illustrating a program module according to the present invention.

Referring to FIG. 3, according to an embodiment of the present invention, a program module 310 (e.g., program 140 of FIG. 1) includes an OS for controlling resources associated with an electronic apparatus (e.g., electronic device 101 of FIG. 1) and/or various applications (e.g., an application program 147 of FIG. 1) running on the operating system. The OS may be, for example, Android, iOS, Windows, Symbian, Tizen®, Bada, and the like.

The program module 310 may include a kernel 320, middleware 330, an API 360, and/or an application 370. At least a part of the program module 310 can be preloaded on the electronic device 101 or downloaded from the server.

The kernel 320 (e.g., the kernel 141 of FIG. 1) includes, for example, a system resource manager 321 or a device driver 323. The system resource manager 321 may control, allocate, or collect the system resources. According to an embodiment of the present invention, the system resource manager 321 includes a process management unit, a memory management unit, a file system management unit, and the like. The device driver 323 includes, for example, a display driver, a camera driver, a BT driver, a shared-memory driver, a USB driver, a keypad driver, a Wi-Fi driver, an audio driver, an inter-process communication (IPC) driver, and the like. According to an embodiment of the present invention, a Wi-Fi driver of the kernel 320 controls at least one of an antenna mode or a transmission period of a network control message for use to transmit and receive signals to and from the communication interface 170 (FIG. 1).

The middleware 330 provides, for example, a function commonly required by the application 370 or provides various functions to the application 370 through the API 360, so that the application 370 can efficiently use limited system resources within the electronic device. According to an embodiment of the present invention, the middleware 330 (e.g., the middleware 143 in FIG. 1) includes, for example, at least one of a runtime library 335, an application manager 341, a window manager 342, a multimedia manager 343, a resource manager 344, a power manager 345, a database manager 346, a package manager 347, a connection manager 348, a notification manager 349, a location manager 350, a graphic manager 351, and a security manager 352.

The runtime library 335 may include, for example, a library module that a compiler uses to add new functions through a programming language while the application 370 is executed. The run time library 335 may perform input/output management, memory management, or a function for an arithmetic function.

The application manager 341 manages, for example, a life cycle of at least one applications of the application 370. The window manager 342 manages graphical user interface (GUI) resources used by a screen. The multimedia manager 343 provides formats required for the reproduction of various media files, and performs encoding or decoding of the media file using a codec suitable for the corresponding format. The resource manager 344 manages resources, such as a source code, a memory, and a storage space of at least one application of the application 370.

The power manager 345 operates together with a basic input/output system (BIOS) to manage a battery or power and may provide power information required for the operation of the electronic device. The database manager 346 generates, searches for, or changes a database to be used by at least one application of the application 370. The package manager 347 manages the installation or the updating of applications distributed in the form of package file.

The connection manager 348 manages wireless connection of, for example, Wi-Fi or BT. The notification manager 349 provides a display or notification of an event, such as an arrival message, a promise, a proximity notification, and the like, in such a way that does not disturb a user. The location manager 350 manages location information of the electronic device. The graphic manager 351 manages graphic effects to be provided to a user and user interfaces related to the graphic effects. The security manager 352 provides all security functions required for system security or user authentication.

The middleware 330 includes a middleware module for forming a combination of various functions of the aforementioned components. The middleware 330 provides modules specialized according to types of operating systems in order to provide differentiated functions. Further, the middleware 330 dynamically removes some of the existing components or adds new components.

The API 360 (e.g., the API 145 of FIG. 1) is, for example, a set of API programming functions, and a different configuration thereof may be provided according to an operating system. For example, with respect to each platform, one API set may be provided in a case of Android or iOS, and two or more API sets may be provided in a case of Tizen.

The application 370 (e.g., the application program 147) includes, for example, one or more applications which can provide functions, such as a home function 371, a dialer 372, an SMS/MMS 373, an instant message (IM) 374, a browser 375, a camera 376, an alarm 377, contacts 378, a voice dialer 379, an email 380, a calendar 381, a media player 382, an album 383, a clock 384, a healthcare function (e.g., to measure calories burned during exercise, or blood sugar levels), and an environment information (e.g., atmospheric pressure, humidity, temperature information, and the like).

According to an embodiment of the present invention, the application 370 includes an application (e.g., an information exchange application) that supports the exchange of information between the electronic device 101 and the external electronic device. The application associated with exchanging information may include, for example, a notification relay application for notifying an external electronic device of certain information or a device management application for managing an external electronic device.

For example, a notification relay application may include a function of transferring the notification information generated by other applications (e.g., an SMS/MMS application, an e-mail application, a healthcare application, an environmental information application, and the like) of the electronic device to the external electronic device. Further, the notification relay application may receive notification information from, for example, the external electronic device and provide the received notification information to the user. For example, the device management application may manage (e.g., install, delete, or update) at least one function (e.g., turning on/off the external electronic device itself (or some elements thereof) or adjusting the brightness (or resolution) of a display) of the external electronic device communicating with the electronic device, applications operating in the external electronic device, or services (e.g., a telephone call service or a message service) provided from the external electronic device.

According to an embodiment of the present invention, the application 370 includes an application (e.g., a health management application) specified according to an attribute (e.g., as an attribute of the electronic device, the type of electronic device is a mobile medical equipment) of the external electronic device. According to an embodiment of the present invention, the application 370 includes an application received from the external electronic device (e.g., a server, an electronic device, and the like). According to an embodiment of the present invention, the application 370 includes a preloaded application or a third party application downloaded from the server. The names of the elements of the program module 310, according to the embodiment illustrated in FIG. 3, may vary according to the type of operating system.

According to the present invention, at least a part of the program module 310 is implemented in software, firmware, hardware, or a combination of two or more thereof. At least a part of the program module 310 is implemented (e.g., executed), for example, by a processor or application program. At least some of the program module 310 includes, for example, a module, program, routine, sets of instructions, or process for performing one or more functions.

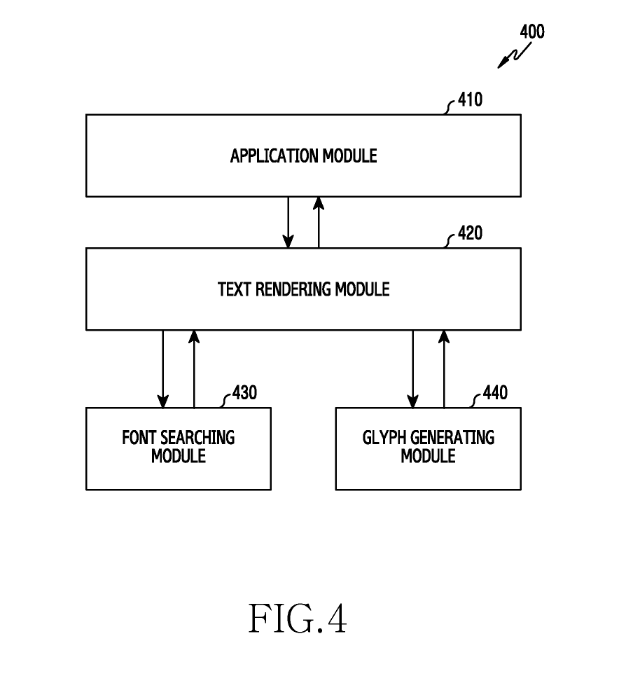

FIG. 4 illustrates interaction of modules of an electronic device for assigning the priority to a font according to an embodiment of the present invention.

Referring to FIG. 4, the electronic device 400 includes an application module 410, a text rendering module 420, a font searching module 430, and a glyph generating module 440.

To display text information on a display of the electronic device 400, the application module 410 sends a request for display of the text information to the text rendering module 420. Here, the text information includes a character, a numeral, a special character, a font, etc., which may be displayed on the display of the electronic device 400. For example, the application module 410 provides a character code (e.g., an American Standard Code for Information Interchange (ASCII) code, a Unicode, etc.) related to the text information to the text rendering module 420, together.

In response to the request for display of the text information from the application module 410, the text rendering module 420 searches and generates a font and glyph of the corresponding text information. According to an embodiment of the present invention, the text rendering module 420 requests font search for text information display, to the font searching module 430. Also, the text rendering module 420 receives a font search list by priority from the font searching module 430. The text rendering module 420 selects and loads a corresponding font that is required for the text information display. The text rendering module 420 stores in a database a loading count and use time of the searched font or selected font. Whenever a specific font is searched or loaded, the text rendering module 420 increases a count of a loading count of the specific font. The text rendering module 420 measures a time when the specific font is searched or loaded, and stores the measured time in the database. The text rendering module 420 may store the counted loading count and the measured use time in real time.

Based on a use frequency and use time of a font stored in the database, the text rendering module 420 assigns a weight to the priority of text information. If a use count or loading count of a font is high, the text rendering module 420 assigns a high weight to the priority of the font. For the latest use time of the font, the text rendering module 420 assigns a high weight to the priority of the font. For example, a font having a high weight is searched preferentially, i.e. searched first, and a font having a low weight is searched later. According to an embodiment of the present invention, the text rendering module 420 sends a request for font loading and letter generation to the glyph generating module 440, and receives a corresponding font from the glyph generating module 440.

An electronic device according to the present invention includes a memory, a display, and a processor for controlling the memory and the display. The processor links text information and use information about the text information and stores the linked text information and use information in a database. The processor analyzes a user preference for the text information based on the use information. The processor determines text information that will be displayed with priority based on the user preference.

The processor stores font information about at least one of a language by country, a numeral, a special character, a font, and a URL or domain address, which are comprised in the text information.

The processor assigns a weight to the priority of the font information based on a use count of the URL and domain address.

The processor stores the text information and at least one of a use frequency, use count, loading count, or use time of the text information, in the database within the memory.

The processor assigns a weight to the priority of the text information based on the loading count and use time of the text information.

The processor rearranges the priority of a corresponding font in accordance with the assigned weight.

The processor receives a request for display of the text information, searches a corresponding font in response to the display request, and selects and loads the searched font.

The processor stores a loading count and loading time of the loaded font in the database.

The processor initializes the stored loading count and loading time of the font.

The processor displays the determined text information through the display.

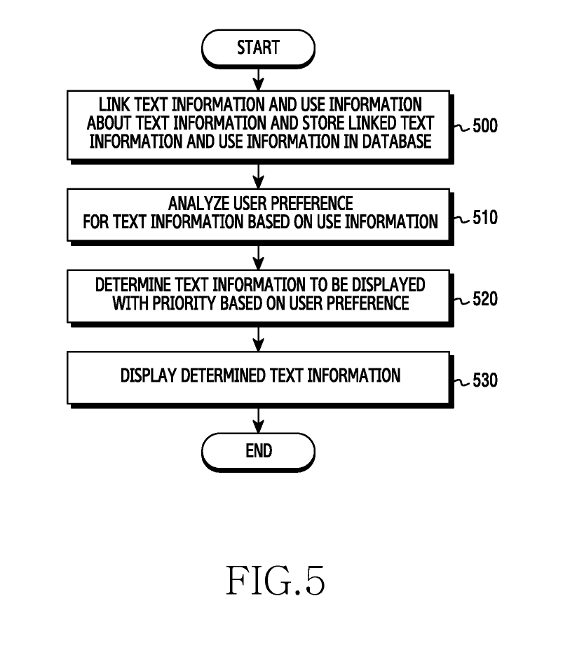

FIG. 5 is a flowchart illustrating a method for determining text information to be displayed with priority based on a user preference according to an embodiment of the present invention.

Referring to FIG. 5, in step 500, the electronic device links text information and use information about the text information and stores the linked text information and use information in a database. Here, the text information includes a character, a numeral, a special character, a font, etc., which may be displayed on a display of the electronic device. The use information includes information about a use frequency (e.g., loading count or use count, etc.) or use time of the corresponding text information. The electronic device receives a request for display of specific text information. Here, the display request may include a character code (e.g., an ASCII code, a Unicode, etc.) related to text information received from a server or external device.

In response to the received display request, the electronic device searches a corresponding font in a font database. For example, the electronic device stores in the database a loading count and use time of a font selected among searched fonts. Whenever a specific font is searched or loaded, the electronic device increases a count of a loading count of the specific font. The electronic device measures a time when the specific font is searched or loaded, and stores the measured time in the database. The electronic device may store the counted loading count and the measured use time in real time.

In step 510, the electronic device analyzes a user preference for the text information based on the use information. The electronic device analyzes the user preference for the text information based on a use frequency and use time of the text information.

Based on a loading count and use time of a font stored in the database, the electronic device assigns a weight to the priority of the font. As a use count or loading count of a font is high, the electronic device assigns a high weight to the priority of the font. For the latest use time of the font, the electronic device assigns a high weight to the priority of the font. For example, a font having a high weight is searched preferentially, and a font having a low weight is searched later. According to an embodiment of the present invention, the user preference for the text information is assigned as a weight dependent on the loading count or use time of the font, but it is not limited to this. For example, the electronic device may set higher a weight dependent on a loading count or use time of specific text information.

In step 520, the electronic device determines text information that will be displayed with priority based on the user preference. When there is a request for display of text information, the electronic device searches the corresponding text information in order of the determined priority.

In step 530, the electronic device displays the determined text information. For example, in response to the display request received from a server or external device, the electronic device displays a corresponding screen. The electronic device may display a webpage such as Naver, Daum, YouTube, etc., on the display through an Internet application.

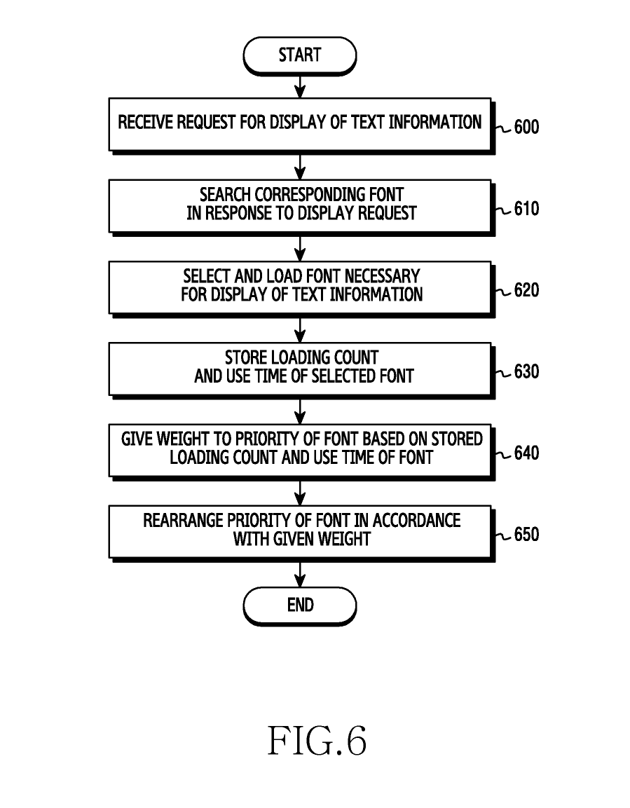

FIG. 6 is a flowchart illustrating a method for rearranging the priority of a font based on a loading count and use time of the font according to an embodiment of the present invention.

Referring to FIG. 6, in step 600, the electronic device receives a request for display of text information. For example, the electronic device receives a forward of a display request for displaying the text information (e.g., a character, a numeral, a special character, a font, etc.) on a display. Here, the display request includes a character code (e.g., an ASCII code, a Unicode, etc.) related to text information received from a server or external device. The electronic device may display a webpage such as Naver, Daum, YouTube, etc., on a screen through an Internet application.

In step 610, in response to the display request, the electronic device searches a corresponding font. Upon receiving a request for display of text information from a server or external device, the electronic device searches in a database a corresponding font for displaying the text information. The database may be previously stored in a memory of the electronic device. The database may include font information about at least one of a language by country, a numeral, a special character, a variety of fonts (e.g., an underline, a script, a tilting font, bold, etc.), a URL, and a domain address which are included in the text information. For example, upon receiving the display request, the electronic device searches a corresponding font in predefined order (e.g., consonant order, etc.) or arbitrary order among a plurality of fonts included in the database.

In step 620, the electronic device selects and loads a font necessary for display of the text information. The electronic device searches and selects a font necessary for display of the text information through the database. The electronic device loads the selected font to generate and displays a font suitable to the requested text information.

In step 630, the electronic device stores a loading count and use time of the selected font. For example, the electronic device stores a loading count and use time of a font selected among fonts searched in the database. Whenever a specific font is loaded, the electronic device increases a count of a loading count of the specific font. The electronic device measures a time when the specific font is loaded, and stores the measured time. The electronic device may update the counted loading count and the measured use time in real time.

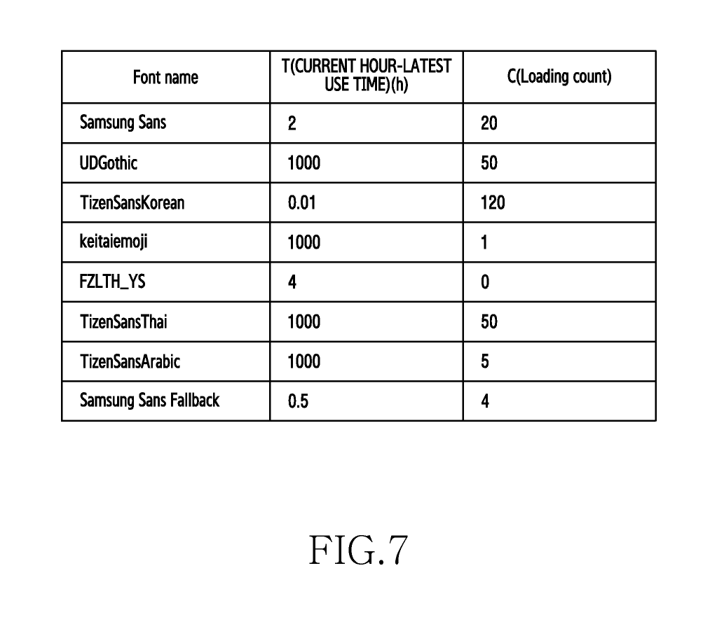

FIG. 7 is a table illustrating a state of storing a loading count and use time of a font according to an embodiment of the present invention.

As illustrated in FIG. 7, a use time (T) of a selected font is equal to a current hour (h) minus a latest use hour (h). For example, a use time (T) of a “Samsung Sans” font may be equal to 2 hours (h) in accordance with a current hour of 08 o'clock minus a latest use hour of 06 o'clock). That is, a low use time (T) of a specific font represents that the specific font has been used lately.

Also, a loading count (C) of the “Samsung Sans” font may represent a number of times of loading of the “Samsung Sans” font in a database for display on a display of the electronic device. Accordingly, if the “Samsung Sans” font is loaded and used twenty times in the electronic device, a loading count (C) of a specific font is high, representing that the specific font has been used frequently. According to embodiments of the present invention, loading counts and use time of fonts (i.e., UDGothic, TizenSansKorean, keitaiemoji, FZLTH_YS, TizenSansThai, TizenSansArabic, Samsung Sans Fallback, etc.) other than the “Samsung Sans” font may be stored and updated, as described above.

In step 640 of FIG. 6, based on the stored loading count and use time of the font, the electronic device assigns a weight to the priority of the font. If the loading count of the font is high, the electronic device assigns a high weight to the priority of the font and, if the use time of the font is low, the electronic device assigns a high weight to the priority of the font.

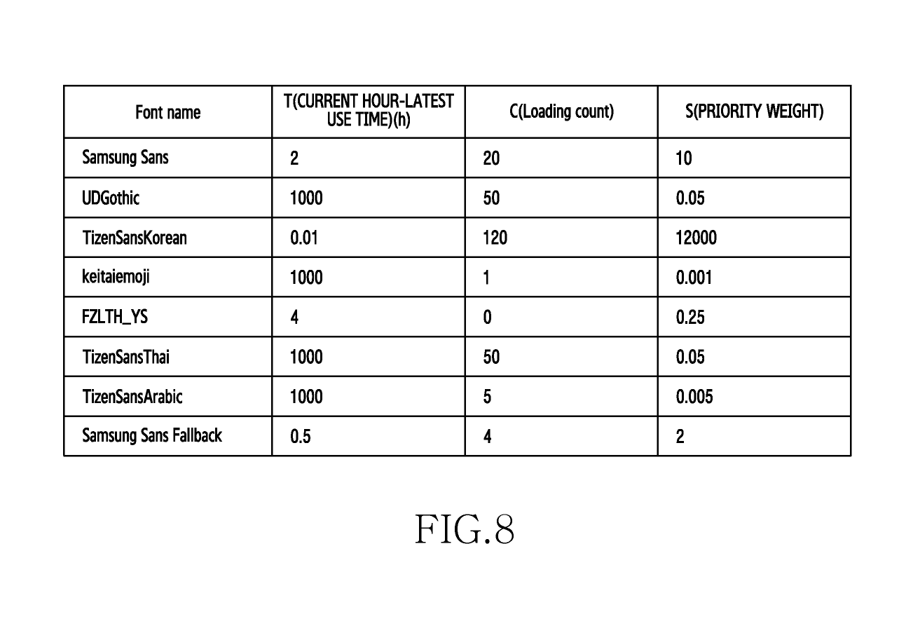

FIG. 8 is a table illustrating determining a priority weight based on a loading count and use time of a font according to an embodiment of the present invention.

As illustrated in FIG. 8, a weight (S) for priority of a font is equal to loading count (C) divided by use time (T). For example, a weight (S) for priority of a “Samsung Sans” font is equal to 10, with a loading count of 20 divided by use time of 2. That is, if a loading count (C) of a font is high, as a use time (T) of the font is low, a weight (S) for priority of the font may be assigned as high. But, it is not so limited, and the weight (S) for priority of the font may be decided diversely in accordance with the loading count (C) of the font and the use time (T) of the font.

In step 650 of FIG. 6, the electronic device rearranges the priority of the font in accordance with the assigned weight. Based on the weight (S) assigned, as in FIG. 8, the electronic device rearranges the priority of each font. For example, among fonts illustrated in FIG. 8, a “TizenSansKorean” font may have the highest priority and a “keitaiemoji” font may have the lowest priority. Upon receiving a request for display of text information, the electronic device performs font search starting from the font having the highest priority, based on the rearranged priority of the font. For example, upon receiving the request for display of the text information, the electronic device first searches the “TizenSansKorean” font having the highest priority and then searches the “Samsung Sans” font. The “keitaiemoji” font having the lowest priority is searched last.

A method for rearranging the priorities of eight fonts based on loading counts and use time of eight fonts has been described, but this does not intend to limit the scope and spirit of the invention. For example, fonts of a language by country, a numeral, a special character, a variety of fonts (e.g., an underline, a script, a tilting font, bold, etc.), etc. displayable on a screen of the electronic device may have priorities as well.

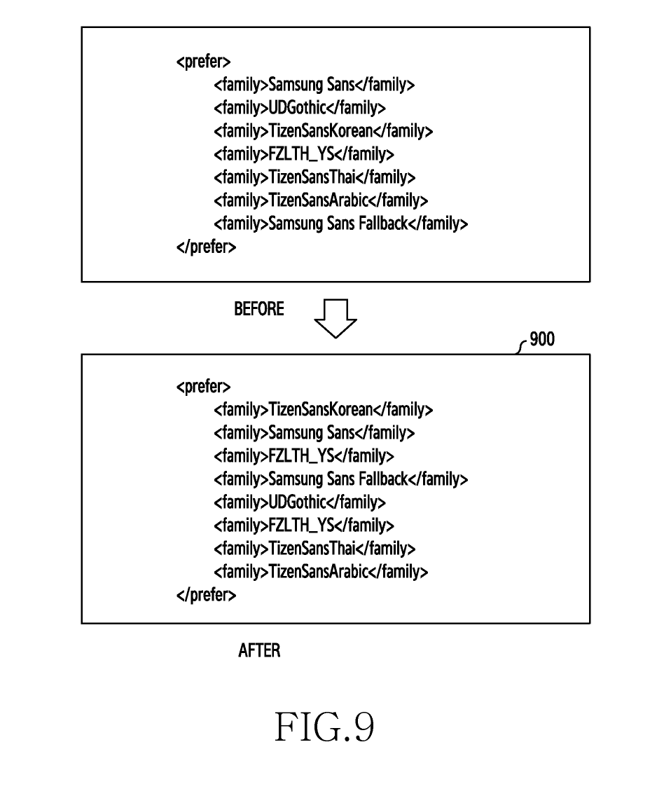

The electronic device may apply an algorithm of rearranging the priority of a font in the aforementioned scheme. FIG. 9 is a diagram illustrating an algorithm of rearranging the priority of a font according to an embodiment of the present invention. As illustrated in FIG. 9, the electronic device may apply an algorithm 900 to shorten a time required for display in the electronic device.

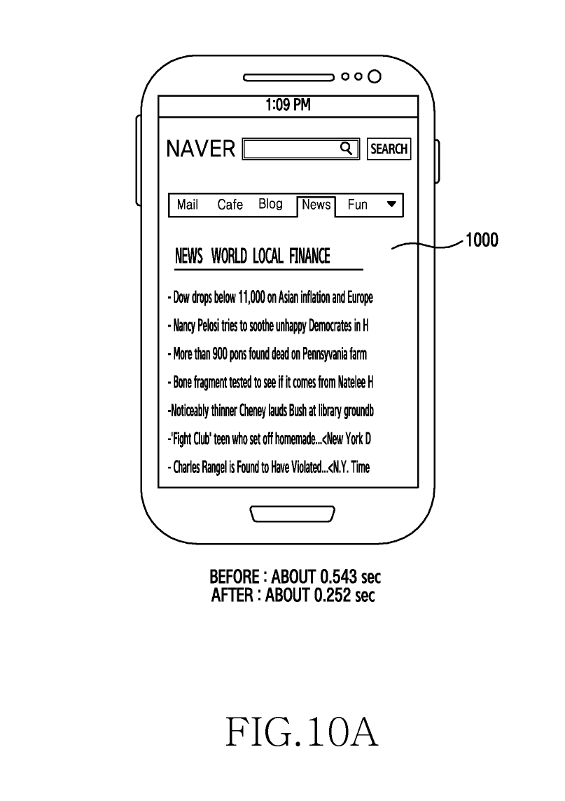

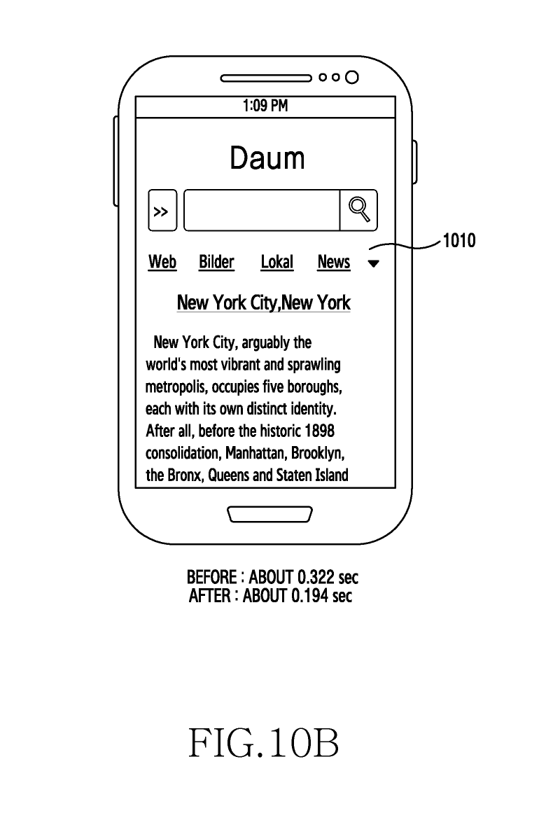

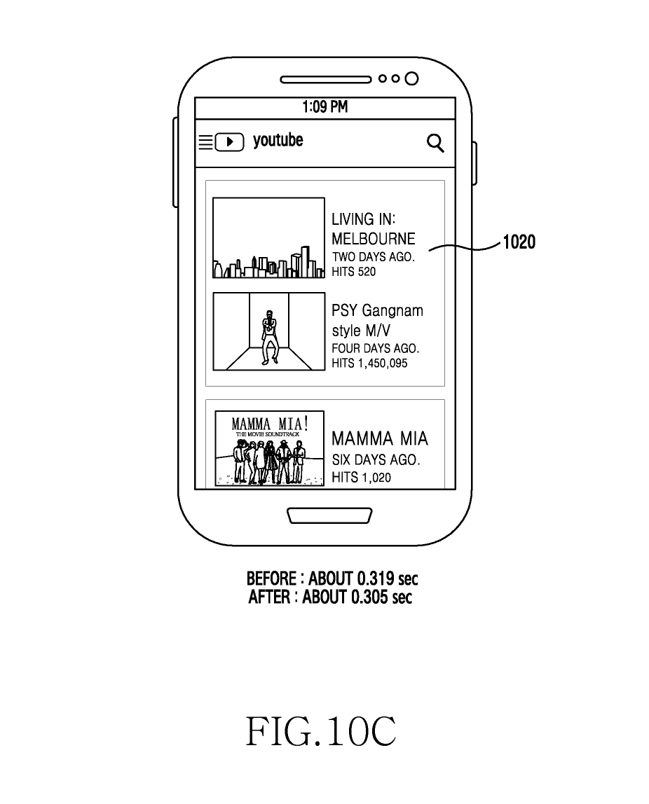

FIG. 10A to FIG. 10C are diagrams showing display wait time before and after applying an algorithm of rearranging the priority of a font according to an embodiment of the present invention.

For example, when running a “Naver” webpage 1010, as in FIG. 10A, the electronic device requires a wait time of about 0.543 seconds before applying the algorithm of rearranging the priority, and may require a wait time of about 0.252 seconds after applying the algorithm. For another example, when running a “Daum” webpage 1010 as in FIG. 10B, the electronic device may require a wait time of about 0.322 seconds before applying the algorithm of rearranging the priority, and may require a wait time of about 0.194 seconds after applying the algorithm. For further example, when running a “YouTube” webpage 1020 as in FIG. 10C, the electronic device may require a wait time of about 0.319 seconds before applying the algorithm of rearranging the priority. Also, the electronic device may require a wait time of about 0.305 seconds after applying the algorithm. Accordingly, display speeds of the webpages executed in the electronic device are improved.

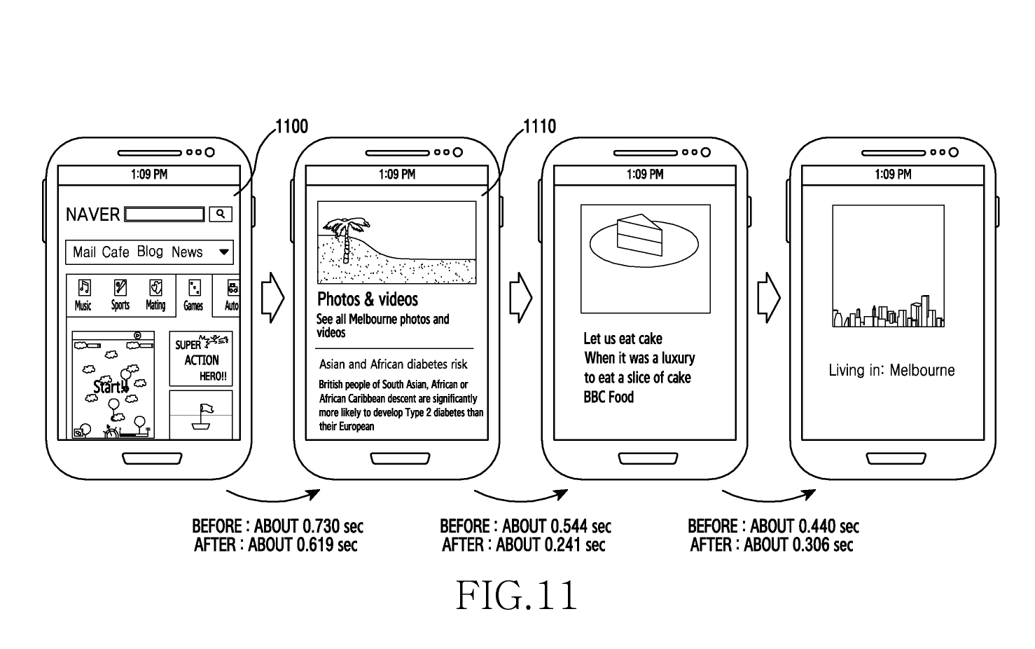

FIG. 11 is a diagram showing a difference of a display wait time when moving from one webpage to other linked webpages according to an embodiment of the present invention. In FIG. 11, if moving to linked another webpage 1110 in a state of displaying a “Naver” webpage 1100, the electronic device may check that a wait time required for displaying the another webpage 1110 is shortened as well. Many characters may be included within the webpage and characters of different kinds are also intermixed, and a wait time required for display is further shortened by using the present invention. Only the webpage displayed on the screen of the electronic device has been described, but it is not limited to this, and it is applicable to a screen including a text having a language by country, a numeral, a special character, and a variety of fonts (e.g., an underline, a script, a tilting font, bold, etc.).

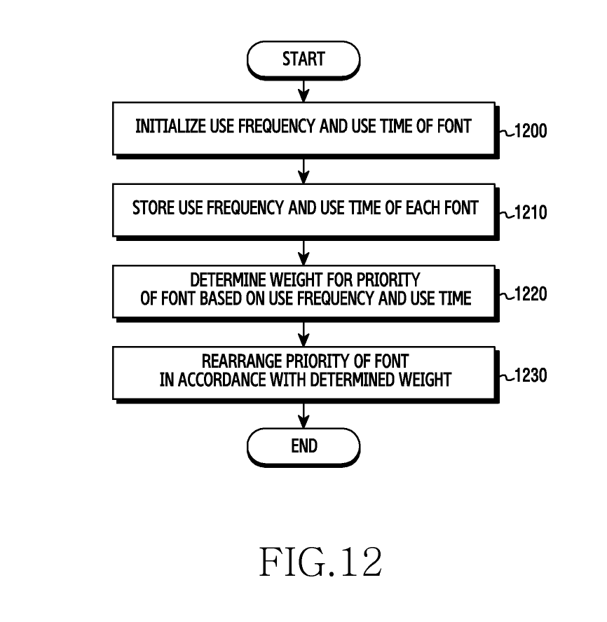

FIG. 12 is a flowchart illustrating a method for rearranging the priority of a font based on a use frequency and use time of the font according to an embodiment of the present invention.

Referring to FIG. 12, in step 1200, the electronic device initializes a use frequency and use time of a font. In response to a request for display of text information (e.g., a character, a numeral, a special character, a font, etc.) stored in a memory of the electronic device, the electronic device initializes the use frequency (e.g., a loading count, a use count, etc.) and use time of the font. Here, the display request includes a character code (e.g., an ASCII code, a Unicode, etc.) related to text information received from a server or external device.

In step 1210, the electronic device stores a use frequency and use time of each font. After initializing the use frequency and use time of the font, the electronic device receives the display request for displaying the text information on the display. The electronic device may display a webpage such as Naver, Daum, YouTube, etc., on a screen through an Internet application. If receiving the display request, the electronic device searches a corresponding font in response to the received display request. For example, the electronic device searches in a database the corresponding font for displaying the text information. The database may be previously stored in the memory of the electronic device. The database may include information about a language by country, a numeral, a special character, and a variety of fonts (e.g., an underline, a script, a tilting font, bold, etc.), which are included in the text information. For example, upon receiving the display request, the electronic device searches a corresponding font in predefined order (e.g., consonant order, etc.) or arbitrary order among a plurality of fonts included in the database.

According to an embodiment of the present invention, the electronic device selects and loads a font necessary for display of the text information. The electronic device searches and selects a font necessary for display of the text information through the database. According to an embodiment of the present invention, the electronic device loads the selected font to generate and display a font suitable to the requested text information. According to an embodiment of the present invention, the electronic device stores a loading count and use time of a font selected among fonts searched in the database. Whenever a specific font is once loaded, the electronic device increases a count of a loading count of the specific font. According to an embodiment of the present invention, the electronic device measures a time when the specific font is loaded, and stores the measured time. The electronic device may update the counted loading count and the measured use time in real time.

As illustrated in FIG. 7, a use time (T) of a selected font may be equal to a current hour (h) minus a latest use hour (h). For example, a use time (T) of a “Samsung Sans” font may be equal to 2 hours (h) in accordance with the current hour of 08 o'clock minus a latest use hour of 06 o'clock). That is, a low use time (T) of a specific font represents that the specific font has been used lately.

Also, a loading count (C) of the “Samsung Sans” font may represent the number of loading the “Samsung Sans” font in a database so as to display on a display of the electronic device. Accordingly, it may be appreciated that the “Samsung Sans” font is loaded and used twenty times in the electronic device. That is, as a loading count (C) of a specific font is high, it may represent that the specific font has been used frequently. According to various exemplary embodiments, loading counts and use time of fonts (i.e., UDGothic, TizenSansKorean, keitaiemoji, FZLTH_YS, TizenSansThai, TizenSansArabic, Samsung Sans Fallback, etc.) other than the “Samsung Sans” font may be stored and updated as above.

The electronic device detects a use count of a URL or a frequently accessed domain address, and assigns a weight to the priority of a specific font. For example, the electronic device checks a country code (e.g., kr, jp, en, zn) of a domain address often visited by a user, and assigns a high weight to a language of a corresponding country. The electronic device assigns a high priority weight of a corresponding font to a frequently used specific application or specific website. The electronic device may generate a font list reflecting the priority of a font suitable to a user's convenience and taste, and use the generated font list for font search as a single virtual font list.

In step 1220 of FIG. 12, based on the use frequency and use time of the font, the electronic device determines a weight for the priority of the font. If loading count of the font is high, the electronic device determines a high weight for the priority of the font. Also, if the use time of the font is low, the electronic device determines a high weight for the priority of the font. According to one exemplary embodiment, as illustrated in FIG. 8, a weight (S) for priority of a font may be equal to (loading count (C)×1/use time (T)). For example, a weight (S) for priority of a “Samsung Sans” font may be equal to 10 in accordance with (loading count (e.g., 20)×1/use time (e.g., 2)). That is, as a loading count (C) of a font is high, as a use time (T) of the font is low, a weight (S) for priority of the font may be given high. But, it is not limited to this, and the weight (S) for priority of the font may be decided diversely in accordance with the loading count (C) of the font and the use time (T) of the font.

In step 1230, the electronic device rearranges the priority of the font in accordance with the determined weight. Based on the weight (S) determined as in FIG. 8, the electronic device rearranges the priority of each font. For example, among fonts illustrated in FIG. 8, a “TizenSansKorean” font may have the highest priority and a “keitaiemoji” font may have the lowest priority. Upon receiving a request for display of text information, the electronic device performs a font search starting from the font having the highest priority, based on the rearranged priority of the font. For example, upon receiving the request for display of the text information, the electronic device first searches the “TizenSansKorean” font having the highest priority and then searches the “Samsung Sans” font. The “keitaiemoji” font having the lowest priority is searched last.

An operation method of an electronic device according to an embodiment of the present invention includes linking text information and use information about the text information and storing the linked text information and use information in a database, analyzing a user preference for the text information based on the use information, and determining text information that will be displayed with priority based on the user preference.

In the method, storing includes storing font information about at least one of a language by country, a numeral, a special character, a font, and a Uniform Resource Locator (URL) or domain address, which are comprised in the text information.

In the method, analyzing assigns a weight to the priority of the font information based on a use count of the URL and domain address.

In the method, storing includes storing the text information and at least one of a use frequency, use count, loading count, or use time of the text information, in the database within a memory.

In the method, analyzing assigns a weight to the priority of the text information based on the loading count and use time of the text information.

The method further includes rearranging the priority of a corresponding font in accordance with the assigned weight.

The method further includes receiving a request for display of the text information, searching a corresponding font in response to the display request, and selecting and loading the searched font.

The method further includes storing a loading count and loading time of the loaded font in the database.

The method further includes initializing the stored loading count and loading time of the font.

The method further includes displaying the determined text information.

Embodiments of the present invention provide a method and electronic device for controlling a display, capable of improving display performance.

Embodiments of the present invention provide a method and electronic device for controlling a display, capable of determining display priority based on a user's preference.

The term “module,” as used herein may represent, for example, a unit including a combination of one or two or more of hardware, software, or firmware. The “module” may be, for example, used interchangeably with the terms “unit”, “logic”, “logical block”, “component”, or “circuit” etc. The “module” may be the minimum unit of an integrally constructed component or a part thereof. The “module” may be also the minimum unit performing one or more functions or a part thereof. The “module” may be implemented mechanically or electronically. For example, the “module” may include at least one of an application-specific integrated circuit (ASIC) chip, Field-Programmable Gate Arrays (FPGAs) and a programmable-logic device performing some operations known to the art or to be developed in the future.

At least a part of an apparatus (e.g., modules or functions thereof) or method (e.g., operations) according to the present invention may be, for example, implemented as instructions stored in a computer-readable storage medium in a form of a programming module. In case that the instruction is executed by a processor (e.g., processor 120), and the processor may perform functions corresponding to the instructions. The computer-readable storage media may be the memory 130, for instance.

The computer-readable recording medium may include a hard disk, a floppy disk, and a magnetic medium (e.g., a magnetic tape), an optical medium (e.g., a Compact Disc-Read Only Memory (CD-ROM) and a Digital Versatile Disc (DVD)), a Magneto-Optical Medium (e.g., a floptical disk), and a hardware device (e.g., a Read Only Memory (ROM), a Random Access Memory (RAM), a flash memory, etc.). Also, the program instruction may include not only a mechanical language code such as a code made by a compiler but also a high-level language code executable by a computer using an interpreter, etc. The aforementioned hardware device may be constructed to operate as one or more software modules in order to perform operations of the present invention, and vice versa.

The module or programming module according to the present invention may include at least one or more of the aforementioned constituent elements, or omit some of the aforementioned constituent elements, or further include additional other constituent elements. Operations carried out by the module, the programming module or the other constituent elements according to the present invention may be executed in a sequential, parallel, repeated or heuristic method. Also, some operations may be executed in different order or may be omitted, or other operations may be added.

Accordingly, a method and electronic device are provided for controlling a display according to the present invention, to determine the priority of display based on a user's preference, thereby being able to decrease a search time for display and more quickly display a desired screen.

While the present disclosure has been shown and described with reference to certain embodiments thereof, it will be apparent to those skilled in the art that the camera lens module according to the present disclosure is not limited to these embodiments, and various changes in form and details may be made therein without departing from the spirit and scope of the present disclosure as defined by the appended claims.

What is claimed is:

1. A method of operating an electronic device, the method comprising:
linking text information and use information about the text information;
storing the linked text information and use information in a database;
analyzing a user preference for the text information based on the use information; and
determining text information that will be displayed with priority based on the user preference.

2. The method of claim 1, wherein storing the linked text information and use information in the database comprises storing font information about at least one of a language by country, a numeral, a special character, a font, and a Uniform Resource Locator (URL) or domain address, which are included in the text information.

3. The method of claim 2, wherein analyzing the user preference for the text information based on the use information comprises assigning a weight to the priority of the font information based on a use count of the URL or domain address.

4. The method of claim 1, wherein storing the linked text information and use information in the database comprises storing the text information and at least one of a use frequency, use count, loading count, or use time of the text information, in the database within a memory.

5. The method of claim 4, wherein analyzing the user preference for the text information based on the use information comprises assigning a weight to the priority of the text information based on the loading count and use time of the text information.

6. The method of claim 5, further comprising rearranging the priority of a corresponding font in accordance with the assigned weight.

7. The method of claim 1, further comprising:
receiving a request for display of the text information;
searching a corresponding font in response to the request; and
selecting and loading the searched font.

8. The method of claim 7, further comprising storing a loading count and loading time of the loaded font in the database.

9. The method of claim 8, further comprising initializing the stored loading count and loading time of the font.

10. The method of claim 1, further comprising displaying the determined text information.

11. An electronic device comprising:
a memory;
a display; and
a processor configured to control the memory and the display,
wherein the processor links text information and use information about the text information, stores the linked text information and use information in a database, analyzes a user preference for the text information based on the use information, and determines text information that will be displayed with priority based on the user preference.

12. The device of claim 11, wherein the processor stores font information about at least one of a language by country, a numeral, a special character, a font, and a Uniform Resource Locator (URL) or domain address, which are included in the text information.

13. The device of claim 12, wherein the processor assigns a weight to the priority of the font information based on a use count of the URL or domain address.

14. The device of claim 11, wherein the processor stores the text information and at least one of a use frequency, use count, loading count, or use time of the text information, in the database within the memory.

15. The device of claim 14, wherein the processor assigns a weight to the priority of the text information based on the loading count and use time of the text information.

16. The device of claim 15, wherein the processor rearranges the priority of a corresponding font in accordance with the assigned weight.

17. The device of claim 11, wherein the processor
receives a request for display of the text information;
searches a corresponding font in response to the request; and
selects and loads the searched font.

18. The device of claim 17, wherein the processor stores a loading count and loading time of the loaded font in the database.

19. The device of claim 18, wherein the processor initializes the stored loading count and loading time of the font.

20. The device of claim 11, wherein the processor displays the determined text information through the display.
